(19) United States
(12) Patent Application Publication
(10) Pub. No.: US 2004/0019514 A1
(43) Pub. Date: Jan. 29, 2004

(54) Submitting and monitoring jobs in peer-to-peer distributed computing

(75) Inventors: Jerome M. Verbeke, Menlo Park, CA (US); Neelakanth M. Nadgir, Menlo Park, CA (US); Gregory R. Ruetsch, Menlo Park, CA (US); Ilya A. Sharapov, Menlo Park, CA (US); Vu H. Trang, Menlo Park, CA (US); Michael J. Vernik, Menlo Park, CA (US)

Correspondence Address: David B. Ritchie, THELEN REID & PRIEST LLP, P.O. Box 640640, San Jose, CA, 95164-0640, US

(73) Assignee: Sun Microsystems, Inc., a Delaware Corporation

(21) Appl. No.: 10/264,927

(22) Filed: Oct. 4, 2002

Related U.S. Application Data
(60) Provisional application No. 60/398,204, filed on Jul. 23, 2002.

(51) Int. Cl. G06F 17/60

(52) U.S. Cl. 705/9

(57) ABSTRACT

The present invention utilizes peer groups in a distributed architecture to decentralize its task dispatching and post-processing functions and to provide the ability to manage and run many different applications simultaneously, in an efficient and reliable manner. Jobs may be submitted to a task dispatcher or to a monitor which distributes the jobs to task dispatchers. Through a series of processes, the task dispatchers may then distribute the jobs to workers. This allows work to be distributed without utilizing a centralized server.

### CROSS-REFERENCE TO RELATED APPLICATION

The present application claims priority based on U.S. Provisional Patent Application serial No. 60/398,204, filed on Jul. 23, 2002, by Jerome M. Verbeke, Neelakanth M. Nadgir, Gregory R. Ruetsch and Ilya A. Sharapov, entitled “FRAMEWORK FOR PEER-TO-PEER DISTRIBUTED COMPUTING IN A HETEROGENEOUS, DECENTRALIZED ENVIRONMENT”, attorney docket no. SUN-P8200P and is related to co-pending application Ser. No. ______, filed on ______, 2002, by Jerome M. Verbeke, Neelakanth M. Nadgir, Gregory R. Ruetsch, Ilya A. Sharapov, Vu H. Trang, Michael J. Vernik, entitled “DISTRIBUTING AND EXECUTING TASKS IN PEER-TO-PEER DISTRIBUTED COMPUTING”, attorney docket no. SUN-P8200.

### FIELD OF THE INVENTION

The present invention relates to the field of computer software. More specifically, the present invention relates to submitting and monitoring jobs in peer groups for improved distributed computing.

### BACKGROUND OF THE INVENTION

Parallel computation has been an essential component of scientific computing for many years. Traditionally, the most popular type of parallel computation has been fine-grained parallelization, which requires substantial inter-node communication utilizing protocols such as Messaging Passing Interface (MPI) or Parallel Virtual Machine (PVM). Recently, however, there has been a growing demand for efficient mechanisms for carrying out computations which exhibit coarse-grained parallelism. The most common application of such mechanisms is distributed computing for large-scale computations. In these, numerous similar, but independent, tasks are performed to solve a large problem, or ensemble averages, where a simulation is run under a variety of initial conditions which are then combined to form the result, are utilized.

Distributed computing has traditionally been implemented using a small network of computers. While this solution works satisfactorily for many applications, it fails to take advantage of the large capacity in existing desktop computing power and network connectivity. More recently, distributed computing frameworks have been designed to help take advantage of the plethora of processors available over the Internet, many of which are not used a great deal of the time (e.g., personal computers).

In the SETI@Home project, data from astronomical measurements is farmed out over the Internet to many processors for processing, and when completed returned to a centralized server and post-processed, in an attempt to aid in the detection of alien species. However, the SETI@Home framework has several disadvantages. First, it is only applicable to a single application. While conceivably the SETI@Home project could be modified or re-created to handle an application other than the search for extraterrestrial life, the framework cannot handle more than one application at a single time. Second, it utilizes a centralized server to distribute and post-process tasks over the network. This can create reliability and efficiency issues if the centralized server is not working properly or is bogged down, or if the network connections to the centralized server are lost.

What is needed is a decentralized computing resource that takes advantage of the many computing resources available on a network and that allows for many applications to be run simultaneously.

### BRIEF DESCRIPTION

The present invention utilizes peer groups in a distributed architecture to decentralize its task dispatching and post-processing functions and to provide the ability to manage and run many different applications simultaneously, in an efficient and reliable manner. Jobs may be submitted to a task dispatcher or to a monitor which distributes the jobs to task dispatchers. Through a series of processes, the task dispatchers may then distribute the jobs to workers. This allows work to be distributed without utilizing a centralized server.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a diagram illustrating an example of a repository peer group in accordance with a specific embodiment of the present invention.

FIG. 2 is a diagram illustrating the interactions between workers, a task dispatcher, and the outside world in accordance with a specific embodiment of the present invention.

FIG. 3 is a diagram illustrating a worker node assuming the role of task dispatcher in accordance with a specific embodiment of the present invention.

FIG. 4 is a diagram illustrating a mechanism used to submit a job or to request a task from a framework in accordance with a specific embodiment of the present invention.

FIG. 5 is a flow diagram illustrating a method for coordinating a job submission in a distributed computing framework in accordance with a specific embodiment of the present invention.

FIG. 6 is a flow diagram illustrating a method for coordinating execution of a task by an idle worker in a distributed computing framework in accordance with a specific embodiment of the present invention.

FIG. 7 is a flow diagram illustrating a method for submitting ajob to a distributed computing environment in accordance with a specific embodiment of the present invention.

FIG. 8 is a flow diagram illustrating a method for submitting a job to a distributed computing environment in accordance with another specific embodiment of the present invention.

FIG. 9 is a flow diagram illustrating a method for adding a worker to a work group in accordance with a specific embodiment of the present invention.

FIG. 10 is a block diagram illustrating an apparatus for coordinating a job submission in a distributed computing framework in accordance with a specific embodiment of the present invention.

FIG. 11 is a block diagram illustrating an apparatus for coordinating execution of a task by an idle worker in a distributed computing framework in accordance with a specific embodiment of the present invention.

FIG. 12 is a block diagram illustrating an apparatus for submitting a job to a distributed computing environment in accordance with a specific embodiment of the present invention.

FIG. 13 is a block diagram illustrating an apparatus for submitting a job to a distributed computing environment in accordance with another specific embodiment of the present invention.

FIG. 14 is a block diagram illustrating an apparatus for adding a worker to a work group in accordance with a specific embodiment of the present invention.

### DETAILED DESCRIPTION

Embodiments of the present invention are described herein in the context of a system of computers, servers, and software. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The present invention is described in this application using the Juxtapose (JXTA) protocols. JXTA was created by Sun Microsystems, Inc. of Palo Alto, Calif. JXTA is a set of protocols that can be implemented by a computer to communicate and collaborate with other peers implementing the JXTA protocols. It attempts to standardize messaging systems, specifically peer-to-peer systems, by defining protocols, rather than implementations. One of ordinary skill in the art will recognize that communication protocols other than JXTA can be utilized to implement the present invention, and the present application should not be read as limiting implementation to JXTA.

In JXTA, every peer is identified by an ID, unique over time and space. Peer groups are user-defined collections of entities (peers) who share a common interest. Peer groups are also identified by unique IDs. Peers can belong to multiple peer groups, can discover other entities (peers and peer groups) dynamically, and can also publish themselves so that other peers can discover them. Three kinds of communication are supported in JXTA. The first kind is called unicast pipe and is similar to User Datagram Protocol (UDP) as it is unreliable. The second type is called secure pipe. The secure pipe creates a secure tunnel between the sender and the receiver, thus creating a secure, reliable transport. The third type is the broadcast pipe. When using the broadcast pipe, the message is broadcast to all the peers in the peer group.

The present invention utilizes peer groups in a distributed architecture to decentralize its task dispatching and post-processing functions and to provide the ability to manage and run many different applications simultaneously, in an efficient and reliable manner. The present invention also provides several other advantages as well. A dynamic grid, where nodes are added and removed during the lifetime of the jobs, is provided. Redundancy, where the dynamic nature of the grid does not affect the results, is also provided. Computational resources are also organized into groups, such that inter-node communications does not occur in a one-to-all or allto-all mode, which would limit the scalabilty of the system. Additionally, heterogeneity, where a wide variety of computational platforms are able to participate, is also provided.

The main roadblock to efficiency in a distributed computing framework is the administration and coordination of tasks and resources. One advantage of utilizing JXTA or other peer-to-peer protocols in the present invention is the concept of peer groups can be leveraged. By utilizing peer groups as a fundamental building block of the framework, one is able to group resources according to functionality, in the process building redundancy and restricting communication messages to relevant peers.

In a specific embodiment of the present invention, the distributed computing framework may contain the following peer groups: (1) the monitor group; (2) the worker group; (3) the task dispatcher group; and (4) the repository group. The monitor group may be a toplevel group which coordinates the overall activity of the framework, including handling request for peers to join the framework and their subsequent assignment of the node to peer groups, and high-level aspects of the job-submission process. The worker group may be the peer group responsible for performing the computations of a particular job, while the task dispatcher group distributes individual tasks to workers. The repository group may serve as a cache for code and data.

One of ordinary skill in the art will recognize that not all four groups need to be present in order to implement the present invention. In fact, each group independently could be implemented on top of other architectures to provide various advantages described above.

A single node can belong to several peer groups in the framework, and likewise there can be many instances of each peer group within the framework. These interconnectivity and redundancy features are critical in handling the dynamic nature of the environment, where resources are added and removed on a regular basis.

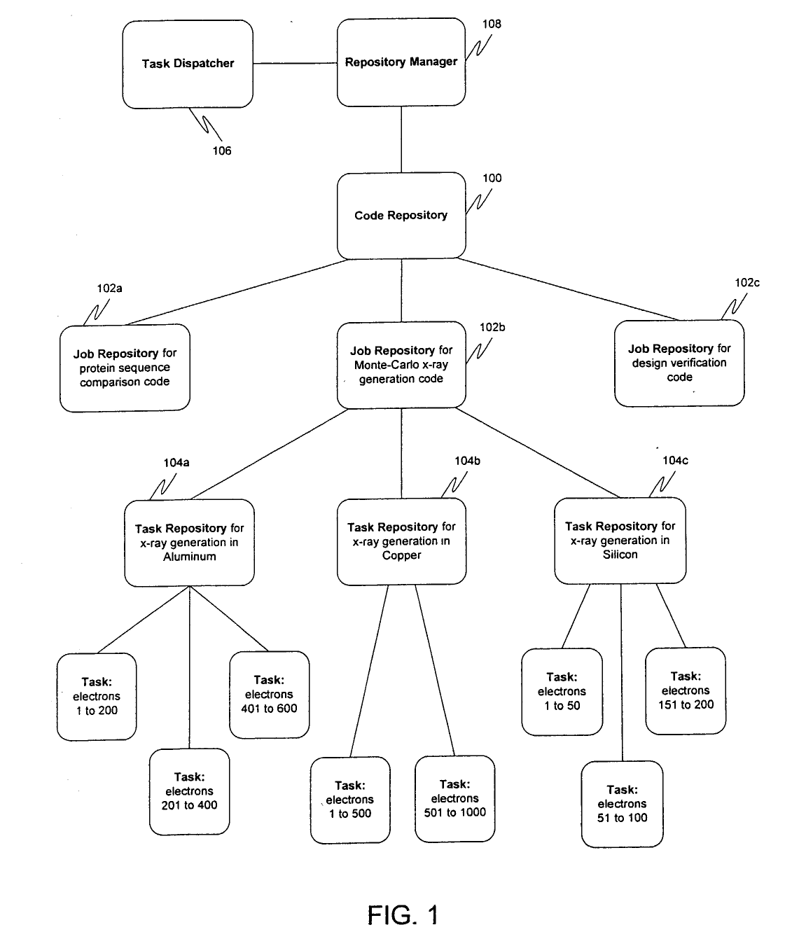

There are two parts to a job: the code used by the worker nodes, which is common for all tasks within the global job, and the data used by the code, which generally varies for each task within a global job. For simplicity, the data used by the code will be referred to as a task. Many types of data are divisible into multiple tasks. The data segment of the job submission can range from being simple parameters which vary from task to task, to large data sets required for computations. The storage of the two elements for a job may be distributed through the network in a decentralized fashion. The management of these components may fall under the repository peer group. FIG. 1 is a diagram illustrating an example of a repository peer group in accordance with a specific embodiment of the present invention. The code repository 100 may contain three codes, each having its own job repository 102a , 102b , 102c . Each job then may then be composed of a different number of tasks 104a , 104b , 104c . The interaction of the code repository group 100 with the rest of the framework may be through the task dispatcher group 106. Upon receiving the job submission, the task dispatcher may poll the repository to determine the status of the code within the code repository. If the repository is current, then the code may be retrieved, and otherwise uploaded and stored in the code repository. For each job, a job repository may be created, which is a tree containing a repository for tasks within the job, which are submitted by the end-user. The task dispatcher need not keep track of the job submitters that contacted it.

In a specific embodiment of the present invention, the submission of a job may proceed as follows. The job submitter may send an Extensible Markup Language (XML) message to the task dispatcher with the an identification (such as a name) of the code to be run. The task dispatcher then may check with the repository manager 108 to see whether the identification of the code to be run is already in the code repository. If it is not in the code repository, then a task dispatcher may request the classes for the code from the job submitter. The job submitter may send the classes for the code to the task dispatcher, which submits them to the repository manager. The latter may create a job repository for this code, where the classes are stored.

Turning now to the worker groups, within each worker group there may be a task dispatcher. Idle workers may regularly poll the task dispatcher relaying information regarding resources available, including codes the worker has; cached. Based on this information, the task dispatcher may poll the repository for tasks to be performed on available codes, or for codes to be downloaded to the workers. Upon distribution of code and tasks, the worker may perform the task and return the result to the task dispatcher. The task dispatcher need not keep track of which workers are performing which tasks.

Handshaking also need not occur between the worker and the task dispatcher. Both are working in such a manner that lost messages do not affect the final completion of a job. As such, a worker could become inaccessible during execution, which would not affect the final completion of a job. The task dispatcher may update the repository with information about task completion, and redundant tasks are performed to account for node failure.

In a specific embodiment of the present invention, the joining of workers to the framework to execute the work contained in the code repository may proceed as follows. Workers may first contact the task dispatcher by sending an XML message. If the worker has recently been working on some codes, it may send a list of recently worked-on codes along with this XML message. Then the task dispatcher may look at the codes sent by the worker and decide based on this which code the worker will be working on. Once the code is determined, it may send the classes required to run the code to the worker. If there are no tasks available for execution in the code repository, the task dispatcher may tell the worker to sleep for a period of time and to check again for work afterwards. This period of time is a tunable parameter. The worker may store the classes in a directory which belongs to its classpath. The reason for this is that it must be able to load these classes dynamically at code execution time. Afterwards, the worker may request tasks for the code from the task dispatcher. The task dispatcher may hand this request to the repository manager. The latter may check whether a job has been submitted for this code, that is if there is a job repository for this code. If several jobs have been submitted, i.e., the job repository contains several task repositories, the repository manager may choose the task repository that was submitted first and of which all the tasks have not yet completed. From this task repository, the repository manager may choose a task that has not yet been submitted to a worker. If all tasks have already been submitted, it may choose a task that has already been submitted but has not completed yet. The chosen task is handed back to the task dispatcher, who sends it to the worker.

The worker gets the task and executes it. Once the execution is complete, the worker sends the task back to the task dispatcher. The returned task contains the results of the execution. The task dispatcher gives the task to the repository manager, who stores them in the relevant repository. At this point, the worker requests another task from the task dispatcher.

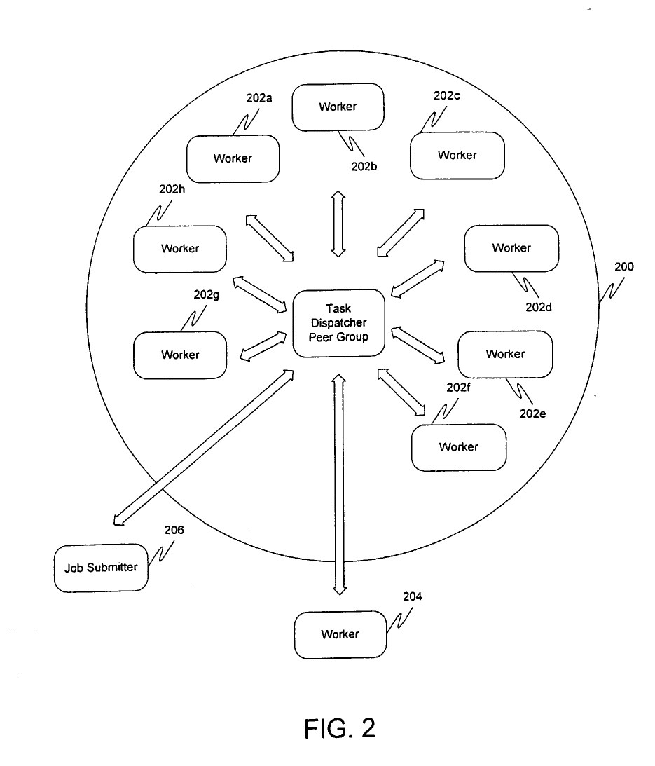

It should be noted that a work group is composed of a group of peers. The access to this peer group is limited and nobody outside of the peer group can access it without special authorization. Using a peer group enables one to limit the intercommunication to a small set of peers. This eliminates processing of messages from the outside world, which would reduce the overall communication bandwidth within the peer group. FIG. 2 is a diagram illustrating the interactions between workers, a task dispatcher peer group, and the outside world in accordance with a specific embodiment of the present invention. The large circle 200 represents a group of peers 202a -202g , which can exchange messages with each other. The only time communication with the outside world is necessary is when a peer outside of the work group wants to establish communication with the task dispatcher peer group. In one case, a worker 204 wants to join the work group. In another case, a job submitter 206 submits a job to the work group.

Once a job has completed, that is, all the tasks in its task repository have completed, the tasks are ready to be sent back to the job submitter. However, the task dispatcher need not keep track of the job submitters. It is therefore up to the job submitter to initiate the result retrieval process. The job submitter has a procedure that polls the task dispatcher to determine whether the job that it submitted has completed. Each job may have a job repository, which has a unique ID. This ID may be sent to the job submitter when the job repository is created, and used to request the results. The task dispatcher may relay this request to the repository, which returns the results if the job has completed. These results may be sent back to the job submitter, and the job submitter retrieves the array of tasks and then postprocesses them.

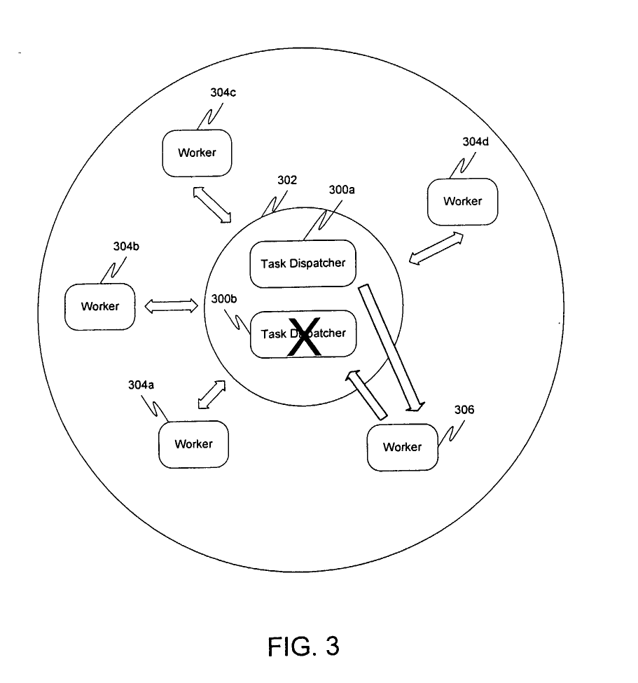

Reliability is an important requirement for distributed computing. Simulations can take days to complete and an outage can result in days of lost time. If the job is amenable to partitioning, it can benefit from the reliability features the present invention implements. FIG. 3 is a diagram illustrating a worker node assuming the role of task dispatcher in accordance with a specific embodiment of the present invention. If there was only a single task dipatcher and it was interrupted, all the results from the tasks executed by the workers who sent their results to the task dispatcher would be lost. Therefore, redundant task dispatchers 300a , 300b may be kept in task dispatcher peer groups 302. With two task dispatchers keeping each other up-to-date with the latest results they have received, the information is not lost if one of them incurs an outage.

A new worker joining a work group does not contact a particular task dispatcher, but the task dispatcher peer group. A task dispatcher may reply to the incoming message. The question of which task dispatcher replies is discussed later in this application. The worker then establishes communication with the task dispatcher. This is illustrated by the workers 304a , 304b , 304c , 304d . In this model, if a task dispatcher fails to respond to a worker, the worker may back out a level and contacts the task dispatcher peer group again. At this time, a different task dispatcher may respond to his request.

Task dispatchers in a peer group may communicate by sending each other messages at regular time intervals. This regular message exchange may be termed the task dispatcher heartbeat. When task dispatchers receive new results from a worker, they may send them to the other task dispatcher to keep a redundant copy of these results. In order to reduce the communication between task dispatchers, the implementation of the model could be such that they update each other with the newest results only during heartbeats.

As soon as a task dispatcher 300a in the same peer group realizes that his redundant counterpart is missing, it may invite a worker 306 requesting a task to execute the task dispatcher code in his peer group, transforming a regular worker into a task dispatcher. This role interchange may be fairly straightforward to implement, because both the worker and task dispatcher codes implement a common interface, making them equally schedulable in this mode.

The number of task dispatchers in the task dispatcher peer group does not necessarily have to be limited to two. Triple or higher redundancy is possible. Also, because the communication protocols can be applied in a large network, the framework can take advantage of the higher reliability offered by having redundant task dispatchers in different geographical regions. By having redundant task dispatchers in different states, for example, a power outage in one state would not result in any loss of information.

As workers are added to a work group, the communication bandwidth between workers and task dispatchers may become a bottleneck. To prevent this, another role may be introduced, the monitor. The main function of the monitor is to intercept requests from peers which do not belong to any peer group yet. Monitors may act as middlemen between work groups and joining peers. Job submitters who want to submit a job and workers who want to join a work group to work on a task may contact a monitor. Monitors free task dispatchers from direct communication with the outside world. Work groups communicate with their monitor and do not see the rest of the communication outside of the work group.

A monitor can have several work groups to monitor and can redirect requests from peers from the outside to any of the work groups it monitors. This redirection will depend on the workload of these subgroups. Just as there are task dispatcher peer groups, there are also monitor peer groups, with several monitors updating each other within a monitor peer group to provide redundancy.

With the addition of monitors, the way jobs are submitted to the framework may be slightly different. Job submitters make requests to the monitor peer group. Monitors within the peer group may redirect these requests to a work group. The choice of this group may depend on what code these work groups are already working on, their workloads, etc. The work group replies directly to the job submitter, which establishes a working relationship with the work group.

The redirection by the top monitor group may happen only once at the initial request by the job submitter to submit a job. Afterwards, messages may be directly sent from the job submitter to the correct work group. A similar protocol may be followed when a new worker wants to join the framework. The role of the monitor is not only to redirect newcomers to the right work groups, but also to monitor the work groups, because it is up to the monitor to decide to which work group a job should be submitted. It may therefore keep track of work group loads, codes, and information about the loss of task dispatchers in a work group.

Monitors can keep each other up to date with the status of the work groups under them with the monitor group heartbeat. Monitors can also request a worker to become a monitor in case of a monitor failure. If too many peers are present in a work group, the communication bandwidth within that group may become a bottleneck. This would also happen if too many work groups are associated with the same monitor peer group. Therefore, the model also enables a hierarchy of monitor peer groups, with each monitor peer group monitoring a combination of work groups and monitor groups. Whenever a monitor group becomes overloaded, it may take the decision of splitting off a separate monitor group, which takes some of the load off the original monitor group.

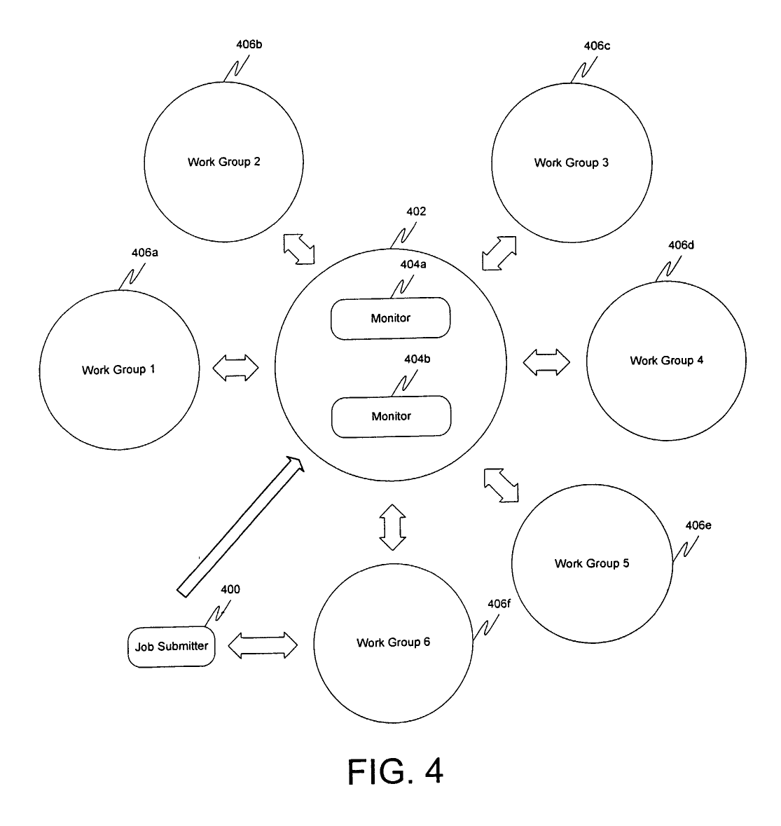

FIG. 4 is a diagram illustrating a mechanism used to submit a job or to request a task from a framework in accordance with a specific embodiment of the present invention. The job submitter 400 or worker contacts the top monitor group 402. Based on the information passed with the message, one of the peers 404a , 404b in the top monitor group may decide which subgroup 406a -406f to hand on the request to, and forward the request to the chosen subgroup. If this subgroup is a monitor group, the message may be forwarded until it reaches a work group. Once the message is in a work group, a task dispatcher in the work group may send a reply to the job submitter/worker. This message may contain the peer ID of the task dispatcher to contact, the ID of the task dispatcher peer group, as well as the peer group IDs of the intermediate peer groups involved in passing down the message. The job submitter/worker at this stage has a point of contact in a new work group. If it fails to contact the task dispatcher, it may successively contact the task dispatcher peer group, its parent, grandparent, etc. until it succeeds in contacting someone in the chain. The last level of the hierarchy is the top-level monitor group.

Because all the new peers joining the framework have to go through the top-level monitor group, the communication at that level might become a bottleneck in the model. One solution to this is the following. When a new peer contacts the top-level monitor group, all the monitors within this peer group receive the message. Each monitor in the monitor group has a subset of requests to which it replies. These subsets do not overlap and put together compose the entire possible set of requests that exist. Based on a request feature, a single monitor takes the request of the new peer and redirects it to a subgroup.

Monitors may decide whether to reply to a given request based on the request itself coming from the new peer. There is no need for communication between monitors to decide who will reply. For example, if there are two monitors in the monitor groups, one monitor could reply to requests from peers having odd peer IDs, while the other monitor could reply to requests from peers having even peer IDs. The decision does not require any communication between the monitors and is therefore beneficial for our model. It reduces the communication needs and increases the bandwidth for other messages. This decision also could be based on the geographical proximity of the requestor to the monitor.

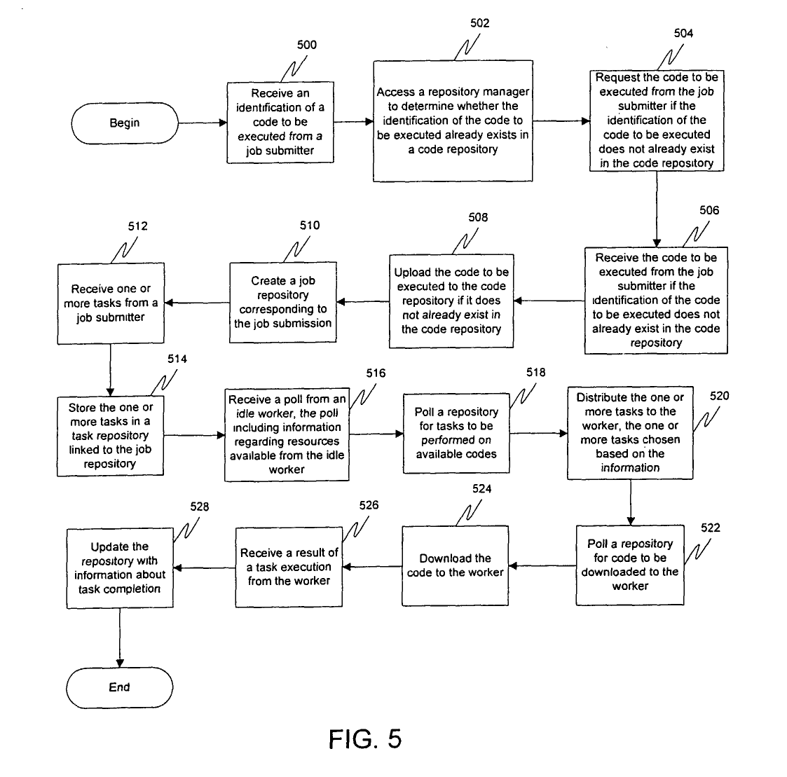

FIG. 5 is a flow diagram illustrating a method for coordinating a job submission in a distributed computing framework in accordance with a specific embodiment of the present invention. At 500, an identification of a code to be executed may be received from a job submitter. At 502, a repository manager may be accessed to determine whether the identification of the code to be executed already exists in a code repository. At 504, the code to be executed may be requested from the job submitter if the identification of the code to be executed does not already exist in the code repository. At 506, the code to be executed may be received from the job submitter if the identification of the code to be executed does not already exist in the code repository. At 508, the code to be executed may be uploaded to the code repository if it does not already exist in the code repository. At 510, a job repository corresponding to the job submission may be created. This may be stored on multiple peers. It may also be a part of a repository peer group. At 512, one or more tasks may be received from ajob submitter. At 514, the one or more tasks may be stored in a task repository linked to the job repository. The creating and storing may be performed by a repository manager. The receiving an identification, uploading, creating, receiving one or more tasks, and storing may be performed using a peer-topeer protocol, such as JXTA. At 516, a poll may be received from an idle worker, the poll including information regarding resources available from the idle worker. This information may include information regarding codes cached by the worker. At 518, a repository may be polled for tasks to be performed on available codes. This may comprise contacting a repository manager. The repository manager may control one or more repositories in a repository peer group. At 520, one or more of the tasks may be distributed to the worker, the one or more tasks chosen based on the information. At 522, a repository may be polled for code to be downloaded to the worker. At 524, the code may be downloaded to the worker. At 526, a result of a task execution may be received from the worker. At 528, the repository may be updated with information about task completion. The receiving a poll, polling a repository, distributing, receiving a result, and updating may be performed using a peer-to-peer protocol, such as JXTA.

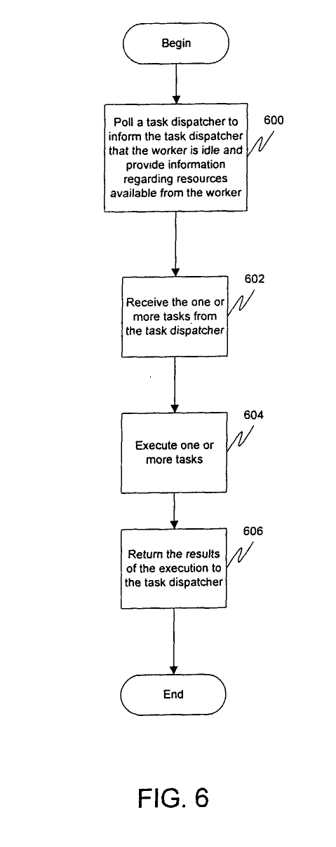

FIG. 6 is a flow diagram illustrating a method for coordinating execution of a task by an idle worker in a distributed computing framework in accordance with a specific embodiment of the present invention. At 600, a task dispatcher may be polled to inform the task dispatcher that the worker is idle and provide information regarding resources available from the worker. This information may include information regarding codes cached by the worker. At 602, the one or more tasks may be received from the task dispatcher. The task dispatcher may be a task dispatcher manager. This may be a task dispatcher that controls one or more task dispatchers ina peer group. At 604, the one or more tasks may be executed. At 606, the results of the execution may be returned to the task dispatcher. The polling, receiving, and returning may be performed using a peer-to-peer protocol, such as JXTA.

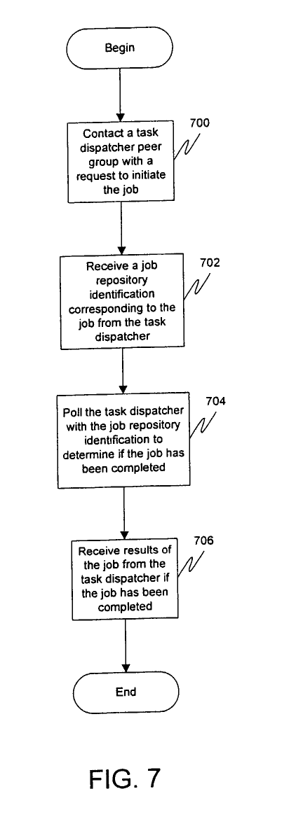

FIG. 7 is a flow diagram illustrating a method for submitting a job to a distributed computing environment in accordance with a specific embodiment of the present invention. At 700, a task dispatcher peer group may be contacted with a request to initiate the job. A task dispatcher in the task dispatcher peer group may handle the request. This task dispatcher may be a task dispatcher manager that controls one or more task dispatchers in a task dispatcher peer group. At 702, a job repository identification corresponding to the job may be received from the task dispatcher. At 704, the task dispatcher may be polled with the job repository identification to determine if the job has been completed. At 706, results of the job may be received from the task dispatcher if the job has been completed. The contacting, receiving a job repository identification, polling, and receiving results may be performed using a peer-to-peer protocol, such as JXTA.

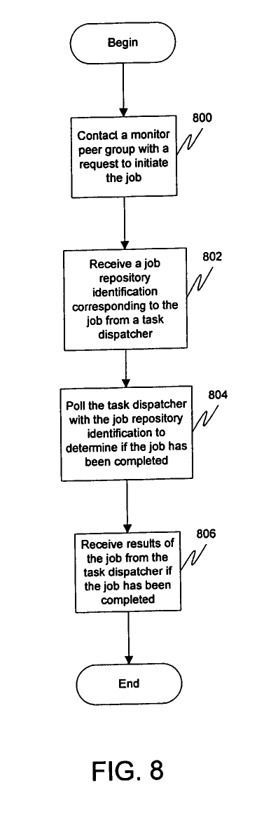

FIG. 8 is a flow diagram illustrating a method for submitting a job to a distributed computing environment in accordance with another specific embodiment of the present invention. At 800, a monitor peer group may be contacted with a request to initiate the job. The monitor may relay this request to a task dispatcher in its choice of workgroup. At 802, a job repository identification corresponding to the job may be received from the task dispatcher. The task dispatcher may be a task dispatcher manager that controls one or more task dispatchers in a task dispatcher peer group. At 804, the task dispatcher may be polled with the job repository identification to determine if the job has been completed. At 806, results of the job may be received from the task dispatcher if the job has been completed. The contacting, receiving ajob repository identification, polling, and receiving results may be performed using a peer-to-peer protocol, such as JXTA.

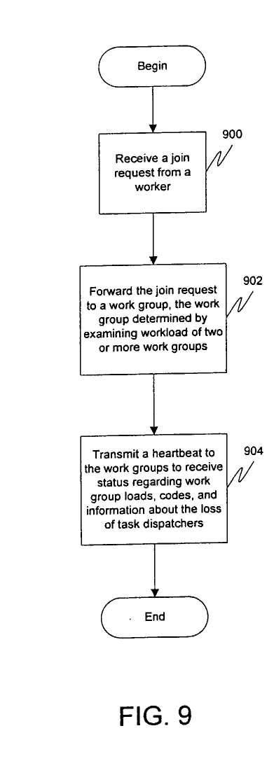

FIG. 9 is a flow diagram illustrating a method for adding a worker to a work group in accordance with a specific embodiment of the present invention. At 900, a join request may be received from a worker. At 902, the join request may be forwarded to a work group, the work group determined by examining workload of two or more work groups. At 904, a heartbeat is transmitted to the work groups to receive status regarding work group loads, codes, and information about the loss of task dispatchers.

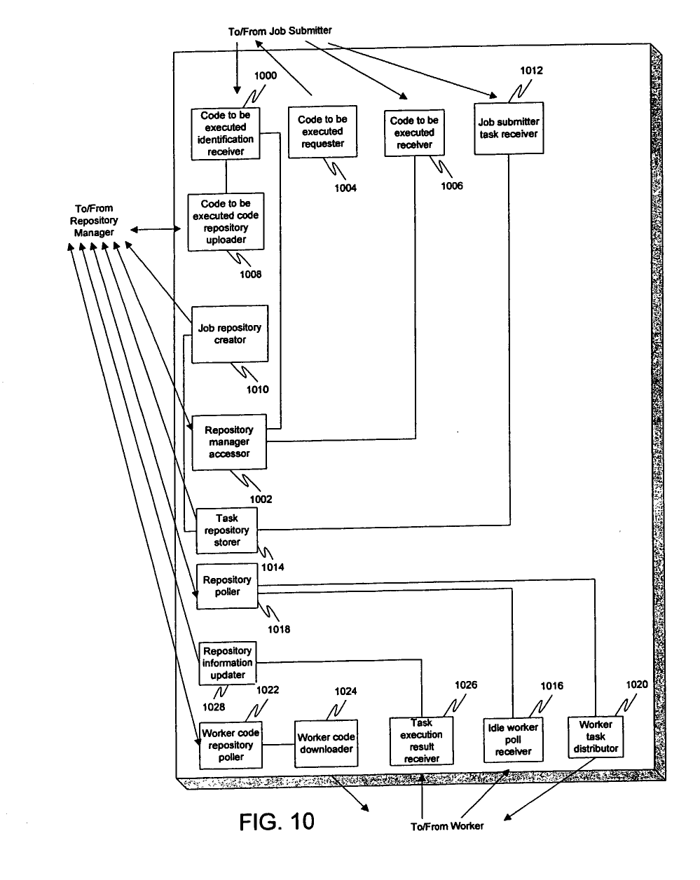

FIG. 10 is a block diagram illustrating an apparatus for coordinating a job submission in a distributed computing framework in accordance with a specific embodiment of the present invention. A code to be executed identification receiver 1000 may receive an identification of a code to be executed from a job submitter. A repository manager accessor 1002 coupled to said code to be executed identification receiver 1000 may access a repository manager to determine whether the identification of the code to be executed already exists in a code repository. A code to be executed requester 1004 coupled to the repository manager accessor 1002 may request the code to be executed from the job submitter if the identification of the code to be executed does not already exist in the code repository. A code to be executed receiver 1006 may then receive the code to be executed from the job submitter if the identification oft he code to be executed does not already exist in the code repository. A code to be executed code repository uploader 1008 coupled to the code to be executed identification receiver 1000 and to the code to be executed receiver 1006 may upload the code to be executed to the code repository if it does not already exist in the code repository. A job repository creator 1010 coupled to the code to be executed identification receiver 1000 may create a job repository corresponding to the job submission. This may be stored on multiple peers. It may also be a part of a repository peer group. A job submitter task receiver 1012 may receive one or more tasks from a job submitter. A task repository storer 1014 coupled to the job submitter task receiver 1012 and to the job repository creator 1010 may store the one or more tasks in a task repository linked to the job repository. The creating and storing may be performed by a repository manager. The receiving an identification, uploading, creating, receiving one or more tasks, and storing may be performed using a peer-to-peer protocol, such as JXTA. An idle worker poll receiver 1016 may receive a poll from an idle worker, the poll including information regarding resources available from the idle worker. This information may include information regarding codes cached by the worker. A repository poller 1018 coupled to the idle worker poll receiver 1016 may poll a repository for tasks to be performed on available codes. This may comprise contacting a repository manager. The repository manager may control one or more repositories in a repository peer group. A worker task distributor 1020 coupled to the repository poller 1018 may distribute one or more of the tasks to the worker, the one or more tasks chosen based on the information. A worker code repository poller 1022 may poll a repository for code to be downloaded to the worker. A worker code downloader 1024 coupled to the worker code repository poller 1012 may download the code to the worker. A task execution result receiver 1026 may receive a result of a task execution from the worker. A repository information updater 1028 coupled to the task execution result receiver 1026 may update the repository with information about task completion. The receiving a poll, polling a repository, distributing, receiving a result, and updating may be performed using a peer-to-peer protocol, such as JXTA.

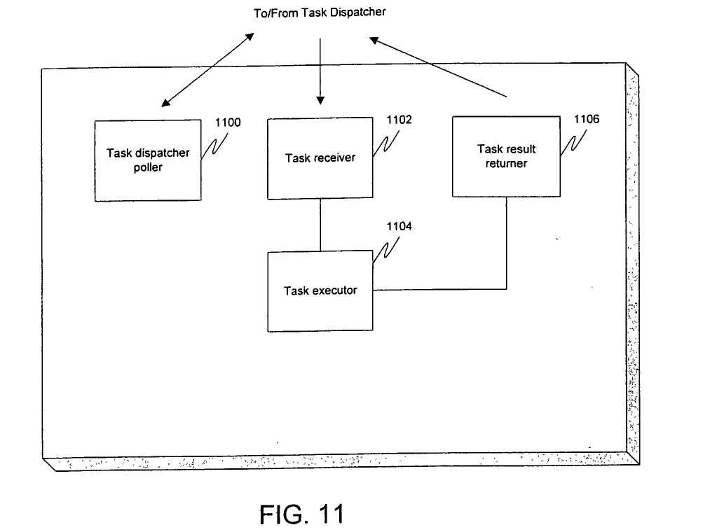

FIG. 11 is a block diagram illustrating an apparatus for coordinating execution of a task by an idle worker in a distributed computing framework in accordance with a specific embodiment of the present invention. A task dispatcher poller 1100 may poll a task dispatcher to inform the task dispatcher that the worker is idle and provide information regarding resources available from the worker. This information may include information regarding codes cached by the worker. A task receiver 1102 may receive the one or more tasks from the task dispatcher. The task dispatcher may be a task dispatcher manager. This may be a task dispatcher that controls one or more task dispatchers in a peer group. A task executor 1104 coupled to the task receiver 1102 may execute the one or more tasks. An execution result returner 1106 coupled to the task executor 1104 may return the results of the execution to the task dispatcher. The polling, receiving, and returning may be performed using a peer-to-peer protocol, such as JXTA.

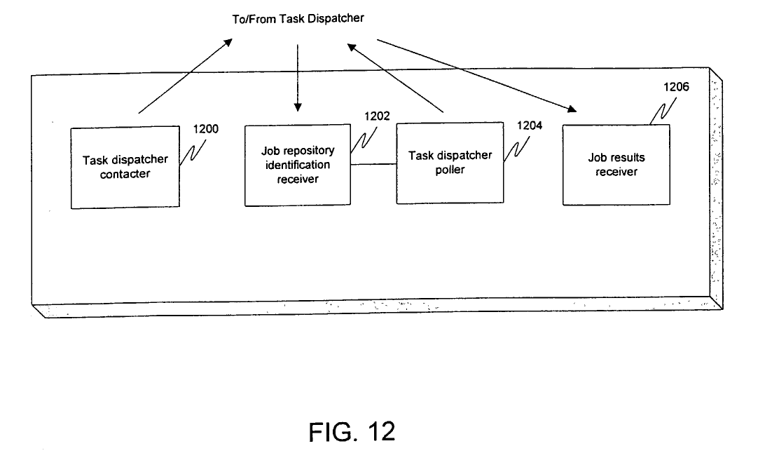

FIG. 12 is a block diagram illustrating an apparatus for submitting a job to a distributed computing environment in accordance with a specific embodiment of the present invention. A task dispatcher contacter 1200 may contact a task dispatcher with a request to initiate the job. The task dispatcher may be a task dispatcher manager that controls one or more task dispatchers in a task dispatcher peer group. A job repository identification receiver 1202 may receive a job repository identification corresponding to the job from the task dispatcher. A task dispatcher poller 1204 coupled to the job repository identification receiver 1202 may poll the task dispatcher with the job repository identification to determine if the job has been completed. A job results receiver 1206 may receive results of the job from the task dispatcher if the job has been completed. The contacting, receiving a job repository identification, polling, and receiving results may be performed using a peer-to-peer protocol, such as JXTA.

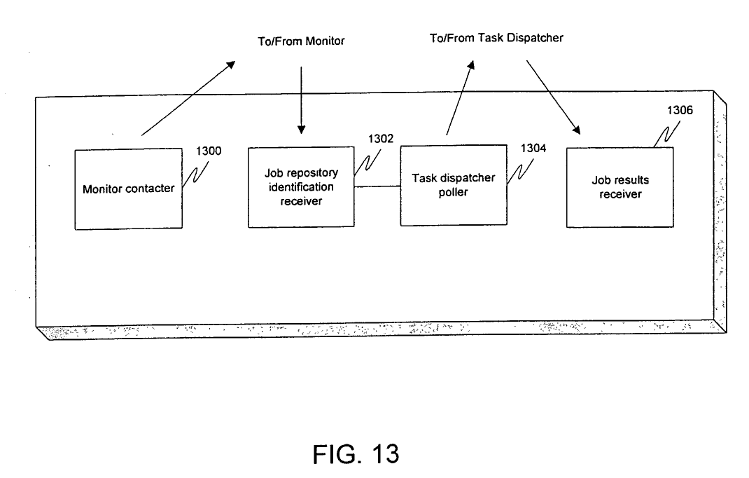

FIG. 13 is a block diagram illustrating an apparatus for submitting a job to a distributed computing environment in accordance with another specific embodiment of the present invention. A monitor contacter 1300 may contact a monitor with a request to initiate the job. A job repository identification receiver 1302 may receive a job repository identification corresponding to the job from the monitor as well as task dispatcher information. The task dispatcher may be a task dispatcher manager that controls one or more task dispatchers in a task dispatcher peer group. A task dispatcher poller 1304 coupled to the job repository identification receiver 1302 may poll the task dispatcher with the job repository identification to determine if the job has been completed. A job results receiver 1306 may receive results of the job from the task dispatcher if the job has been completed. The contacting, receiving a job repository identification, polling, and receiving results may be performed using a peer-to-peer protocol, such as JXTA.

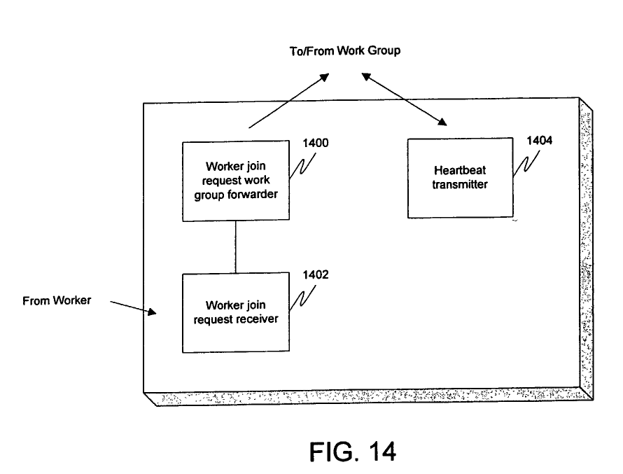

FIG. 14 is a block diagram illustrating an apparatus for adding a worker to a work group in accordance with a specific embodiment of the present invention. A worker join request receiver 1400 may receive a join request from a worker. A worker join request work group forwarder 1402 coupled to the worker join request receiver 1400 may forward the join request to a work group, the work group determined by examining workload of two or more work groups. A heartbeat transmitter 1404 may transmit a heartbeat to the work groups to receive status regarding work group loads, codes, and information about the loss of task dispatchers.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for submitting a job to a distributed computing environment, comprising:
contacting a task dispatcher peer group with a request to initiate the job;
receiving a job repository identification corresponding to the job from a task dispatcher in said task dispatcher peer group;
polling said task dispatcher with said job repository identification to determine if the job has been completed; and
receiving results of the job from said task dispatcher if the job has been completed.

2. The method of claim 1, wherein said task dispatcher is a task dispatcher manager.

3. The method of claim 1, wherein said task dispatcher manager controls one or more task dispatchers in a task dispatcher peer group.

4. The method of claim 1, wherein said contacting, receiving, polling, and receiving are performed using a peer-to-peer protocol.

5. The method of claim 4 wherein said peer-to-peer protocol is Juxtapose (JXTA).

6. A method for submitting a job to a distributed computing environment, comprising:
contacting a monitor peer group with a request to initiate the job;
receiving a job repository identification corresponding to the job from a task dispatcher;
polling said task dispatcher with said job repository identification to determine if the job has been completed; and
receiving results of the job from said task dispatcher if the job has been completed.

7. The method of claim 6, wherein said task dispatcher is a task dispatcher manager.

8. The method of claim 7, wherein said task dispatcher manager controls one or more task dispatchers in a task dispatcher peer group.

9. The method of claim 6, wherein said contacting, receiving, polling, and receiving are performed using a peer-to-peer protocol.

10. The method of claim 9 wherein said peer-to-peer protocol is Juxtapose (JXTA).

11. A method for adding a worker to a work group, comprising:
receiving a join request from a worker; and
forwarding said join request to a work group, said work group determined by examining workload of two or more work groups.

12. The method of claim 11, further comprising transmitting a heartbeat to said work groups to receive status regarding work group loads, codes, and information about the loss of task dispatchers and workers.

13. A framework for distributed computing in an environment with a plurality of computers and with no centralized server, comprising:
one or more workers organized in a group, said one or more workers selected from the plurality of computers;
one or more task distributors for said group, said one or more task distributors selected from the plurality of computers; and
one or more repositories, said one or more repositories selected from the plurality of computers.

14. The framework of claim 13, further comprising one or more monitors, said one or more monitors selected from the plurality of computers.

15. The framework of claim 13, further comprising a repository manager, said repository manager selected from the plurality of computers.

16. The framework of claim 13, wherein said one or more workers execute code stored in said one or more repositories on data stored in said one or more repositories.

17. The framework of claim 13, wherein said one or more task distributors distribute tasks to said one or more workers.

18. The framework of claim 13, wherein said one or more repositories include one or more code repositories, one or more task repositories, and one or more job repositories.

19. The framework of claim 18, further comprising a repository manager, said repository manager selected from the plurality of computers.

20. An apparatus for submitting a job to a distributed computing environment, comprising:
a task dispatcher contacter;
a job repository identification receiver;
a task dispatcher poller coupled to said job repository identification receiver; and
a job results receiver.

21. An apparatus for submitting a job to a distributed computing environment, comprising:
a monitor contacter;
a job repository identification receiver;
a task dispatcher poller coupled to said job repository identification receiver; and
a job results receiver.

22. An apparatus for adding a worker to a work group, comprising:
a worker join request receiver; and
a worker join request work group forwarder coupled to said worker join request receiver.

23. The apparatus of claim 22, further comprising a heartbeat transmitter.

24. An apparatus for submitting a job to a distributed computing environment, comprising:
means for contacting a task dispatcher peer group with a request to initiate the job;
means for receiving a job repository identification corresponding to the job from a task dispatcher in said task dispatcher peer group;
means for polling said task dispatcher with said job repository identification to determine if the job has been completed; and
means for receiving results of the job from said task dispatcher if the job has been completed.

25. The apparatus of claim 24, wherein said task dispatcher is a task dispatcher manager.

26. The apparatus of claim 25, wherein said task dispatcher manager controls one or more task dispatchers in a task dispatcher peer group.

27. The apparatus of claim 24, wherein said means for contacting, means for receiving, means for polling, and means for receiving use a peer-to-peer protocol.

28. The apparatus of claim 27 wherein said peer-to-peer protocol is Juxtapose (JXTA).

29. An apparatus for submitting a job to a distributed computing environment, comprising:
means for contacting a monitor peer group with a request to initiate the job;
means for receiving a job repository identification corresponding to the job from a task dispatcher;
means for polling said task dispatcher with said job repository identification to determine if the job has been completed; and
means for receiving results of the job from said task dispatcher if the job has been completed.

30. The apparatus of claim 29, wherein said task dispatcher is a task dispatcher manager.

31. The apparatus of claim 30, wherein said task dispatcher manager controls one or more task dispatchers in a task dispatcher peer group.

32. The apparatus of claim 29, wherein said means for contacting, means for receiving, means for polling, and means for receiving use a peer-to-peer protocol.

33. The apparatus of claim 32 wherein said peer-to-peer protocol is Juxtapose (JXTA).

34. An apparatus for adding a worker to a work group, comprising:
means for receiving a join request from a worker; and
means for forwarding said join request to a work group, said work group determined by examining workload of two or more work groups.

35. The apparatus of claim 34, further comprising means for transmitting a heartbeat to said work groups to receive status regarding work group loads, codes, and information about the loss of task dispatchers and workers.

36. A program storage device readable by a machine, tangibly embodying a program of instructions executable by the machine to perform a method for submitting a job to a distributed computing environment, the method comprising:
means for contacting a task dispatcher peer group with a request to initiate the job;
means for receiving a job repository identification corresponding to the job from a task dispatcher in said task dispatcher peer group;
means for polling said task dispatcher with said job repository identification to determine if the job has been completed; and
means for receiving results of the job from said task dispatcher if the job has been completed.

37. A program storage device readable by a machine, tangibly embodying a program of instructions executable by the machine to perform a method for submitting a job to a distributed computing environment, the method comprising:
means for contacting a monitor peer group with a request to initiate the job;
means for receiving a job repository identification corresponding to the job from a task dispatcher;
means for polling said task dispatcher with said job repository identification to determine if the job has been completed; and
means for receiving results of the job from, said task dispatcher if the job has been completed.

38. A program storage device readable by a machine, tangibly embodying a program of instructions executable by the machine to perform a method for adding a worker to a work group, the method comprising:
means for receiving a join request from a worker; and
means for forwarding said join request to a work group, said work group determined by examining workload of two or more work groups.
